(19) United States
(12) Patent Application Publication
(10) Pub. No.: US 2018/0068543 A1
(43) Pub. Date: Mar. 8, 2018

(54) Systems and Methods for Fitting a Tracking Device to a Limb

(71) Applicant: BI Incorporated, Boulder, CO (US)

(72) Inventors: Larry T. Cooper, Berthoud, CO (US); Richard Wallace Miller, JR., Longmont, CO (US)

(21) Appl. No.: 15/257,249

(22) Filed: Sep. 6, 2016

(51) Int. Cl. G08B 21/02; G08B 21/04

(52) U.S. Cl. CPC G08B 21/0288; G08B 21/0453

(57) ABSTRACT

Various embodiments of the present invention are related to monitoring movement, and in particular to systems and methods for supporting target monitoring.

### BACKGROUND OF THE INVENTION

The present invention is related to monitoring movement, and in particular to systems and methods for supporting target monitoring.

Large numbers of individuals are currently monitored as part of parole requirements or other requirements. Such monitoring allows a monitoring agency to determine whether the individual is engaging in acceptable patterns of behavior, and where an unacceptable behavior is identified to stop such behavior going forward. One-piece tracking systems have become the standard with a package including tracking circuitry attachable to a limb by a strap. In some cases, attachment of such a one-piece tracking system to a small limb is problematic leading to the possibility of improper operation or loss of the device.

Thus, for at least the aforementioned reasons, there exists a need in the art for more advanced approaches, devices and systems for monitoring.

### BRIEF SUMMARY OF THE INVENTION

The present invention is related to monitoring movement, and in particular to systems and methods for supporting target monitoring.

This summary provides only a general outline of some embodiments according to the present invention. Many other objects, features, advantages and other embodiments of the present invention will become more fully apparent from the following detailed description, the appended claims and the accompanying drawings and figures.

### BRIEF DESCRIPTION OF THE DRAWINGS

A further understanding of the various embodiments of the present invention may be realized by reference to the figures which are described in remaining portions of the specification. In the figures, similar reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1a is a block diagram illustrating a monitoring system including an articulating monitor device attachable to a limb using a strap in accordance with various embodiments of the present invention;

FIG. 1b is a block diagram of an articulating monitor device including three pieces each connected by movable connecting elements allowing for articulation of each of the three pieces relative to one another, and including a strap connecting two of the three pieces;

FIG. 1c shows one implementation of the articulating monitor device of FIG. 1b;

FIG. 1d shows the implementation of the articulating monitor device of FIG. 1c with a removable battery department detached;

FIG. 1e is another view of the articulating monitor device of FIG. 1c showing movable connecting elements connecting respective pieces of the articulated monitoring device;

FIG. 1f shows an example of articulation by an articulating monitor device in accordance with some embodiments when the articulating monitor device is deployed around a relatively large human leg;

FIG. 1g shows an example of articulation by an articulating monitor device in accordance with some embodiments when the articulating monitor device is deployed around a relatively small human leg;

FIG. 1h shows an articulating monitor device in accordance with one or more embodiments deployed around a leg of a human subject; and

FIG. 2 is a flow diagram depicting a method for using an articulating monitor device in accordance with one or more embodiments of the present inventions.

### DETAILED DESCRIPTION OF THE INVENTION

The present invention is related to monitoring movement, and in particular to systems and methods for supporting target monitoring.

Various embodiments of the present inventions provide monitoring systems that include an articulating monitor device and a strap. The articulating monitor device includes at least a first piece connected to a second piece by a first movable connecting element, and a third piece connected to the second piece by a second movable connecting element. A power source is incorporated into one of the first piece, the second piece or the third piece; and location determination circuitry is incorporated into different one of the first piece, the second piece or the third piece. The strap is operable to secure the articulating monitor device to a monitor target such that at least the first piece and the third piece contact the monitor target when the strap is installed.

In some instances of the aforementioned embodiments, the transmission circuitry is incorporated into one of the first piece, the second piece or the third piece. In such instances, the monitoring system further includes a central monitoring system operable to receive location information from the articulating monitor device via the transmission circuitry. In various instances, subject monitoring circuitry is incorporated into different one of the first piece, the second piece or the third piece. In some cases, the subject monitoring circuitry includes one or more of the following: an alcohol sensor circuit, a heart rate sensor circuit, and an oxygen sensor circuit.

In one or more instances of the aforementioned embodiments, the first movable connecting element is a first hinge and the second movable connecting element is a second hinge. In some cases, the first hinge includes a first hinge side connected to both the first piece and the second piece and a second hinge side connected to both the first piece and the second piece. The articulating monitor device includes at least a power conductor and a signal conductor extending between the first hinge side and the second hinge side and electrically connecting the first piece to the second piece.

In various instances of the aforementioned embodiments, the strap includes an electrical conductor operable to conduct an electrical signal between a first contact incorporated in the first piece and a second contact incorporated in the third piece. In particular instances of the aforementioned embodiments, a first inner surface of the first piece is curvilinear to conform to a curved shape of a limb, and a second inner surface of the third piece is curvilinear to conform to the curved shape of the limb. In some instances of the aforementioned embodiments, the power source is a rechargeable battery, and the rechargeable battery is removable from the second piece. In other instances of the aforementioned embodiments, the power source includes both a removable battery incorporated in the second piece and a non-removable battery incorporated in at least one of the first piece, the second piece, or the third piece. The removable battery is detachable from the second piece and rechargeable.

Other embodiments of the present inventions provide methods for monitoring the location of a monitor target. The methods include providing an articulating monitor device having at least a first piece connected to a second piece by a first movable connecting element, and a third piece connected to the second piece by a second movable connecting element. A power source is incorporated into one of the first piece, the second piece or the third piece; and location determination circuitry is incorporated into different one of the first piece, the second piece or the third piece. The methods further include connecting a strap between the first piece and the second piece around the limb of the monitor target.

Yet other embodiments of the present inventions provide multi-piece monitoring devices that include: a first piece having a first hinge element and a second hinge element integral to the second piece; a second piece having a third hinge element integral to the second piece, where the first piece is connected to the second piece using the first hinge element and the third hinge element; a third piece having a fourth hinge element integral to the third piece, where the third piece is connected to the first piece using the second hinge element and the fourth hinge element; and a strap extending from the third piece and operable to connect to the second piece to secure the monitoring device around a limb of a monitor target. A power source is incorporated into one of the first piece, the second piece or the third piece; and location determination circuitry is incorporated into one of the first piece, the second piece or the third piece.

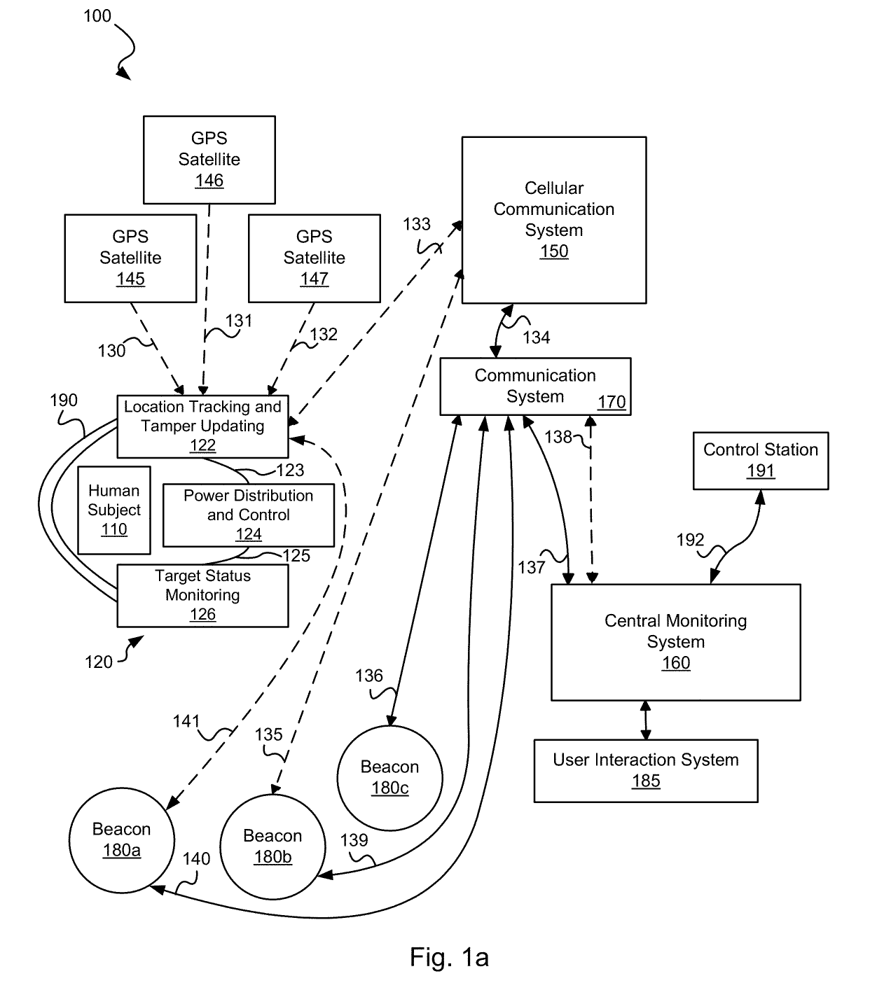

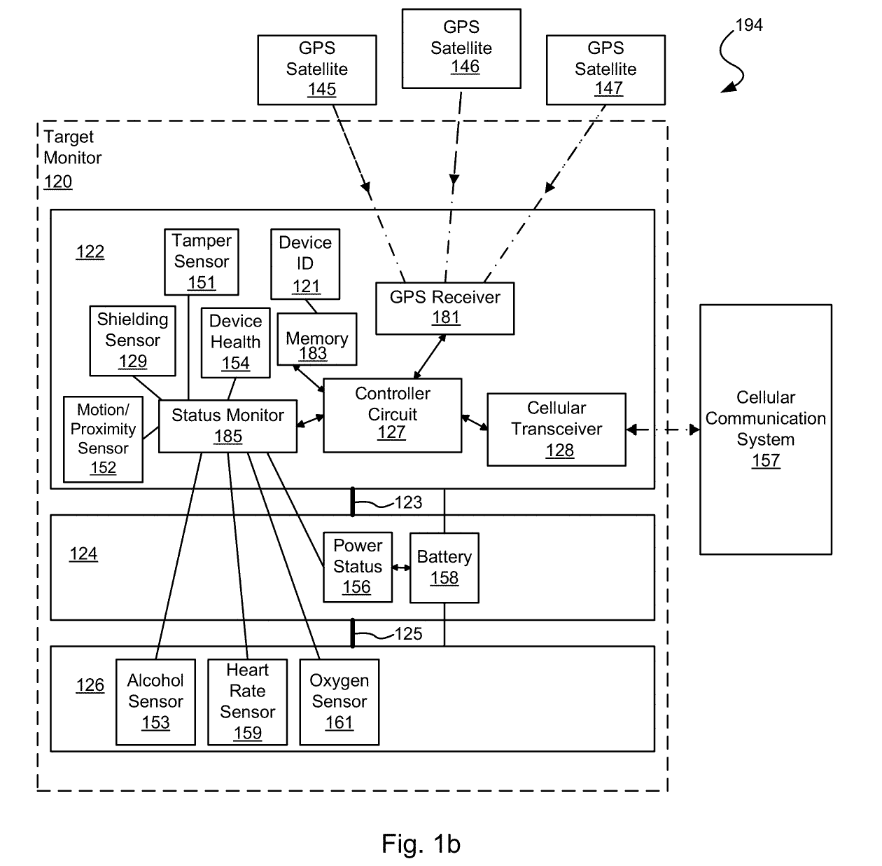

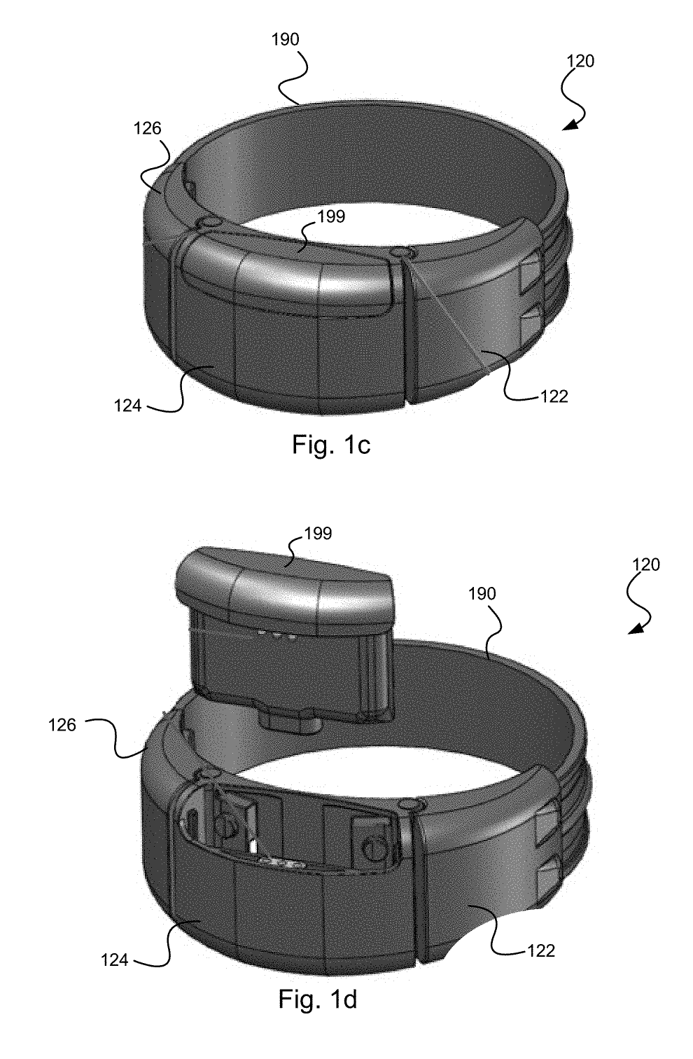

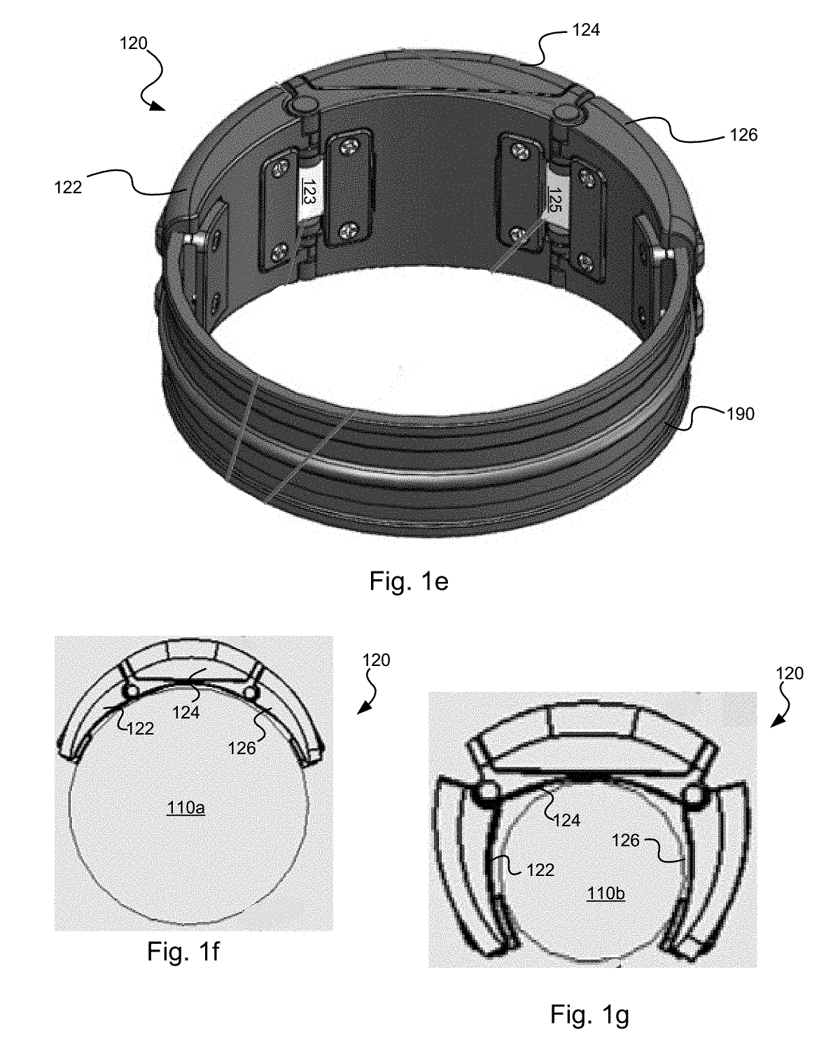

Turning to FIG. 1a, a monitoring system 100 including an articulating monitor device 120 attachable to a limb (represented as a human subject 110) using a securing device 190 is shown in accordance with various embodiments of the present invention. Monitoring system 100 may be tailored for tracking human subjects, however, it should be noted that various implementations and deployments of monitoring system 100 may be tailored for tracking non-human targets such as, for example, other animals. Based upon the disclosure provided herein, one of ordinary skill in the art will recognize a variety of individuals and/or animals that may be monitored in accordance with different embodiments of the present invention, and/or different monitoring scenarios or systems that may be modified to incorporate one or more features disclosed herein.

Monitoring system 100 includes, but is not limited to, articulating monitor device 120 that is physically coupled to a human subject 110 by securing device 190. In some cases, securing device 190 is a strap that includes a tamper sensor 151 that may be, but is not limited to, a continuity sensor that when broken indicates an error or tamper condition. Further, in some cases, tamper sensor 151 may be implemented as a proximity sensor that is able to detect when it has been moved away from an individual being monitored. When such movement away from the individual is detected, an error or tamper condition may be indicated. Based on the disclosure provided herein, one of ordinary skill in the art will recognize a variety of tamper sensors that may be incorporated in either articulating monitor device 120 or securing device 190 to allow for detection of removal of articulating monitor device 120 or other improper or unexpected meddling with articulating monitor device 120.

Articulating monitor device 120 includes three pieces 122, 124, 126 each connected to another by a movable connecting element 123, 125. Movable connecting elements 123, 125 allow for respective ones of pieces 122, 124, 126 to move relative to one another such that pieces 122, 124, 126 contact a limb of human subject 110 when securing device 190 is tightened around the limb. It should be noted that while three pieces are shown, two pieces or four or more pieces may be used in relation to different embodiments. By using multiple pieces connected together via movable connecting elements, with the combination of the multiple pieces and the movable connecting elements being secured in place by a securing device, articulating monitor device 120 may be held securely in place around a small limb that may not accommodate a larger single piece device.

In some embodiments, each of pieces 122, 124, 126 include different circuitry performing different functions. In this particular embodiment, piece 122 includes location tracking and tamper updating circuitry, piece 124 includes power distribution and control circuitry, and piece 126 includes target status monitoring circuitry. The location and tamper updating circuitry is operable to identify a location of articulating monitor device 120 and to indicate any improper tampering with articulating monitor device 120. Power distribution and control circuitry includes a rechargeable battery along with wiring and control to distribute power from the rechargeable battery. The target status monitoring circuitry is operable to determine the status of human subject including, but not limited to, heart rate and alcohol consumption. In some cases, one of piece 122 or piece 126 may be removed where the corresponding functionality is not needed. Further, in other embodiments the distribution of functional circuitry between different pieces may be different.

In operation, the location and tamper updating circuitry of piece 122 provides the location of human subject 110 (i.e., the location of articulating monitor device 120) under a number of conditions. For example, when articulating monitor device 120 is capable of receiving wireless GPS location information 130, 131, 132 from a sufficient number of GPS satellites 145, 146, 147 respectively, articulating monitor device 120 may use the received wireless GPS location information to calculate or otherwise determine the location of human subject 110. Alternatively or in addition, the location of a beacon 180 that is local to articulating monitor device 120 may be used as the location of articulating monitor device 120. As yet another alternative, an AFLT (i.e., advanced forward link trilateration) fix may be established based on cellular communication with articulating monitor device 120. It should be noted that other types of earth based triangulation may be used in accordance with different embodiments of the present invention. Based on the disclosure provided herein, one of ordinary skill in the art will recognize other types of earth based triangulation that may be used.

As yet another alternative, an AFLT fix may be established based on cellular communications between the location tracking and tamper updating circuitry of articulating monitor device 120 and a cellular communication system 150. Furthermore, when wireless communication link 133 between articulating monitor device 120 and cellular communications system 150 is periodically established, at those times, articulating monitor device 120 may report status and other stored records including location fixes to a central monitoring system 160 via wireless communication link 138.

Monitoring system 100 includes, but is not limited to, at least one beacon 180. Beacons 180 are instrumental for beacon based monitoring systems. Within FIG. 1, a telemetric wireless link 141 has been depicted between beacon 180a and articulating monitor device 120. Each beacon 180 has an adjustable range to make telemetric wireless contact with articulating monitor device 120. At any point in time, depending on each beacon's 180 relative distance to articulating monitor device 120, none, one, or more than one tracking beacons 180 may be within transmission range of a single articulating monitor device 120. Likewise, it is further conceivable under various circumstances that more than one articulating monitor device 120 at times be within in range of a solitary beacon 180.

Telemetric wireless communications path 141 established at times between tracking beacon 180a and articulating monitor device 120 illustrates a common feature of various different embodiments of the current invention. Some embodiments of the various inventions vary on how, i.e. protocol, and what information and/or signaling is passed over wireless link 141. For example, in more simplified configurations and embodiments, each beacon 180 is limited to repetitively transmitting its own beacon ID and physical location information. In that way, once articulating monitor device 120 is within transmission range of tracking beacon 180a and establishes wireless or wired reception 141, then articulating monitor device 120 can record and store received beacon ID and location information. At a later time, for some embodiments of the present invention, articulating monitor device 120 can then report recorded readings from beacons 180 to the central monitoring system 160 over the cellular communication system 150 using wireless links 133 and 138 as depicted in FIG. 1. Furthermore, many embodiments allow for such transmissions and information passing to occur without being noticed by human subject 110, and unnoticed, automatically, and near effortlessly central monitoring system 160 is able to establish records and track human subject's 110 movements and whereabouts.

In other embodiments or configurations according to the present invention, each beacon 180 also transmit status information related to its own device health and information related from each beacon's 180 internal tampering, movement, or other sensors via a communication system 170 to central monitoring system 160. This allows for detection of movement of beacons 180, and establishing some level of confidence that the location reported by each of beacons 180 is accurate. Various other details about a beacon based system are disclosed in U.S. patent application Ser. No. 12/041,746 entitled “Beacon Based Tracking Devices and Methods for Using Such” and filed Mar. 4, 2008 by Buck et al. The entirety of the aforementioned reference is incorporated herein by reference for all purposes.

Likewise, in some other embodiments, each articulating monitor device 120 contains a host of their own power status, tampering, shielding, movement, and/or other sensors related to its own device health. In some cases, the target status monitoring circuitry of piece 126 extracts information, and for later reporting, related to physical properties of human subject 110. For example, measuring for the presence of alcohol and/or other drugs present in human subject 110 may be included in some embodiments of articulating monitor device 120. As one example, the alcohol sensor discussed in U.S. Pat. No. 7,930,927 entitled “Transdermal Portable Alcohol Monitor and Methods for Using Such” and filed by Cooper et al. on Mar. 4, 2008. The entirety of the aforementioned reference is incorporated herein by reference for all purposes.

Beacons 180 in alternative embodiments of the present invention may communicate with central monitoring system 160 independently of articulating monitor device 120. The monitoring system 100 illustrated in FIG. 1a shows beacon 180b having both a wireless communication link 135 with cellular communication system 150, and also illustrates beacon 180b having a hardwired communication link 139 with land communication system 170. Monitoring system 100 is also shown with beacons 180a, 180b, and 180c each having hardwired land communication links 140, 139, and 136 respectively to land communication system 170. Monitoring system 100 further illustrates land communication system 170 having a hardwired communication link 134 to cellular communication system 150, and a hardwired communication link 137 to central monitoring system 160.

In some embodiments of the present invention, beacons 180 are located in areas frequented by human subject 110 where articulating monitor device 120 is incapable of accessing information from the GPS system. Such beacons eliminate the need to perform an AFLT fix and avoid the costs associated therewith. As an example, human subject 110 may have a tracking beacon 180 placed within his home, and one also placed at his place of employment in close proximity to his work area. In this way, the two placed beacons, each at different prescribed times, can interact with his attached articulating monitor device 120 to periodically make reports to central monitoring system 160 to track movements and the whereabouts of human subject 110. All this can be done without incurring the costs associated with performing an AFLT fix.

Monitoring system 100 further includes a control station 191 that is communicably coupled to central monitoring system 160 via a communication link 192. In one particular embodiment of the present invention, control station 191 is a personal computer including a display device, a processor, and/or one or more I/O devices. Based upon the disclosure provided herein, one of ordinary skill in the art will recognize a variety of systems that may be used as control station 191 including highly tailored application specific control systems. A storage medium 194 is communicably coupled to control station 191 and maintains instructions governing the operation of pursuit mode control in relation to central monitoring system 160 and articulating monitor device 120.

Turning to FIG. 1b, a block diagram 194 of articulating monitor device 120 including three pieces 122, 124, 126 each connected by movable connecting elements 123, 125 allowing for articulation of each of the three pieces relative to one another is shown in accordance with one or more embodiments of the present invention. In addition, flexible circuit wires transfer signals, information, and/or power between the respective pieces 122, 124, 126. In particular, power is provided from piece 124 to both of pieces 122 and 126. Power status information is transferred from piece 124 to piece 122. Alcohol information, heart rate information, and oxygen information is transferred from piece 126 to piece 122 via piece 124.

As shown, piece 122 includes a device ID 121 that may be maintained in a memory 125, and thus is accessible by a controller circuit 127. Controller circuit 127 is able to interact with GPS receiver 181 and memory 125 at times for storing and generating records of successively determined GPS locations. Where articulating monitor device 120 is operating in a standard mode, controller circuit 127 causes an update and reporting of the location of target monitor device via a cellular transceiver 128 and a cellular communication system 157 in accordance with a first time period. In contrast, where articulating monitor device 120 is operating in a pursuit mode, controller circuit 127 causes an update and reporting of the location of target monitor device via cellular transceiver 128 and cellular communication system 157 in accordance with a second time period. Based upon the disclosure provided herein, one of ordinary skill in the art will recognize various durations for the first time period and the second time period in accordance with different embodiments of the present invention. In some embodiments of the present invention, one or both of the first time period and the second time period is/are user programmable. Operating articulating monitor device 120 in the pursuit mode consumes substantially more power than in the standard mode. Controller circuit 127 may be, but is not limited to, an application specific circuit configured to perform control functions for target monitor. Memory 183 may be any type of memory known in the art such as, for example, a EEPROM or RAM memory. In some cases where controller circuit 127 executes instructions, such instructions may be maintained in memory 183.

Controller circuit 127 of articulating monitor device 120 at times functions in conjunction with cellular transceiver 128 to send and receive data and signals through cellular communication system 190. This link at times is useful for passing information and/or control signals between a central monitoring system (not shown) and pieces 122, 124, 126 of articulating monitoring device 120. The information transmitted may include, but is not limited to, location information from piece 122, alcohol information from piece 126, and information about the status of articulating monitoring device 120 from each of pieces 122, 124, 126. Based on the disclosure provided herein, one of ordinary skill in the art will recognize a variety of information that may be transferred via cellular communication system 190.

Various embodiments of articulating monitor device 120 include a variety of sensors capable of determining the status of articulating monitor device 120, and of the individual associated therewith. For example, a status monitor 185 may include one or more of the following subcomponents: a power status sensor 156 capable of indicating a power status of articulating monitor device 120. The aforementioned subcomponents may be distributed across pieces 122, 124, 126. For example, a power status 156 may be included with a battery 158 in piece 124. An alcohol sensor 153, a heart rate sensor 159 and an oxygen sensor 161 are implemented in piece 126. A set of shielding sensors 129 that are capable of determining whether articulating monitor device 120 is being shielded from receiving GPS signals and/or if GPS jamming is ongoing, a set of device health indicators 154, a tamper sensor 131 capable of determining whether unauthorized access to articulating monitor device 120 has occurred or whether articulating monitor device 120 has been removed from an associated human subject, a motion/proximity sensor 152 capable of determining whether articulating monitor device 120 is moving and/or whether it is within proximity of an individual associated with articulating monitor device 120. Thus, location, device status and reporting functionality is primarily implemented in piece 122, power functionality is implemented in piece 124, and characteristics of human subject 110 are implemented in piece 126. Based on the disclosure provided herein, one of ordinary skill in the art will recognize a variety of shielding sensors, a variety of device health transducers and indicators, a variety of tamper sensors, various different types of motion sensors, different proximity to human sensors, and various human body physical measurement sensors or transducers that may be incorporated into articulating monitor device 120 according to various different instances and/or embodiments of the present invention.

Turning to FIG. 1c, one implementation of articulating monitor device 120 of FIG. 1b is shown including securing device 190, three pieces 122, 124, 126, and a removable battery compartment 199 in which battery 158 is implemented. Turning to FIG. 1d, the implementation of articulating monitor device 120 of FIG. 1c is shown with removable battery department 199 detached from piece 124. Turning to FIG. 1e, another view of articulating monitor device 120 of FIG. 1c is shown that depicts movable connecting elements 123, 125. Turning to FIG. 1f, an example of articulation by articulating monitor device 120 is shown in accordance with some embodiments when articulating monitor device 120 is deployed around a relatively large human leg 110a. In contrast, FIG. 1g shows an example of articulation by articulating monitor device 120 in accordance with some embodiments when articulating monitor device 120 is deployed around a relatively small human leg 110b. Turning to FIG. 1h, articulating monitor device 120 is shown deployed around a human leg 110.

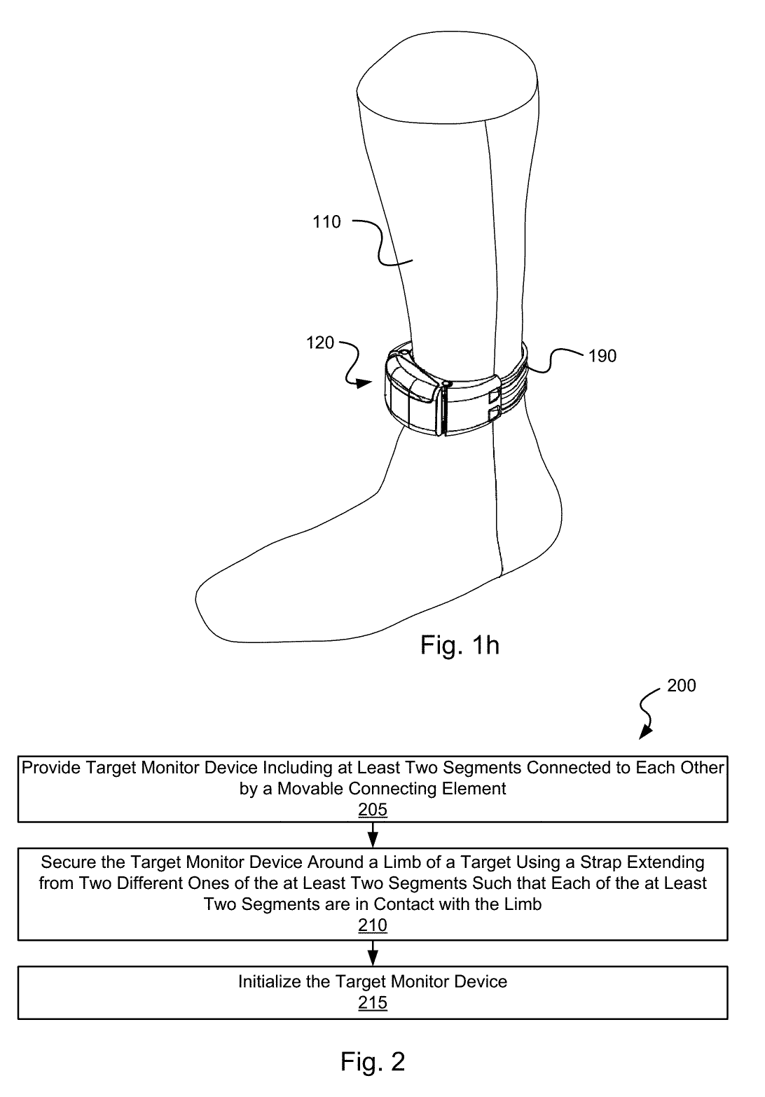

Turning to FIG. 2, a flow diagram 200 depicts a method for using an articulating monitor device in accordance with one or more embodiments of the present inventions. Following flow diagram 200, a target monitor device is provided that includes at least two segments or pieces connected to each other by a movable connecting element (block 205). The target monitor device is secured around the limb of a target using a strap extending from two different ones of the at least two segments such that each of the at least two segments are in contact with the limb (block 210). The target monitor device is initialized and used for monitoring the target (block 215).

In conclusion, the present invention provides for novel systems, devices, and methods for monitoring individuals and/or assets. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A monitoring system, the monitoring system comprising:
an articulating monitor device having at least a first piece connected to a second piece by a first movable connecting element, and a third piece connected to the second piece by a second movable connecting element; wherein a power source is incorporated into one of the first piece, the second piece or the third piece; and wherein location determination circuitry is incorporated into different one of the first piece, the second piece or the third piece; and
a strap operable to secure the articulating monitor device to a monitor target such that at least the first piece and the third piece contact the monitor target when the strap is installed.

2. The monitoring system of claim 1, wherein transmission circuitry is incorporated into one of the first piece, the second piece or the third piece, and wherein the monitoring system further comprises:
a central monitoring system operable to receive location information from the articulating monitor device via the transmission circuitry.

3. The monitoring system of claim 1, wherein subject monitoring circuitry is incorporated into different one of the first piece, the second piece or the third piece.

4. The monitoring system of claim 3, wherein the subject monitoring circuitry includes one or more of the following: an alcohol sensor circuit, a heart rate sensor circuit, and an oxygen sensor circuit.

5. The monitoring system of claim 1, wherein the first movable connecting element is a first hinge and the second movable connecting element is a second hinge.

6. The monitoring system of claim 5, wherein the first hinge includes a first hinge side connected to both the first piece and the second piece and a second hinge side connected to both the first piece and the second piece, and wherein the articulating monitor device includes at least a power conductor and a signal conductor extending between the first hinge side and the second hinge side and electrically connecting the first piece to the second piece.

7. The monitoring system of claim 1, wherein the strap includes an electrical conductor operable to conduct an electrical signal between a first contact incorporated in the first piece and a second contact incorporated in the third piece.

8. The monitoring system of claim 1, wherein a first inner surface of the first piece is curvilinear to conform to a curved shape of a limb, and wherein a second inner surface of the third piece is curvilinear to conform to the curved shape of the limb.

9. The monitoring system of claim 8, wherein the limb is a human leg.

10. The monitoring system of claim 1, wherein the power source is a rechargeable battery, and wherein the rechargeable battery is removable from the second piece.

11. The monitoring system of claim 1, wherein the power source includes both a removable battery incorporated in the second piece and a non-removable battery incorporated in at least one of the first piece, the second piece, or the third piece; and wherein the removable battery is detachable from the second piece and rechargeable.

12. The monitoring system of claim 1, wherein the articulating monitor device is attached to a human.

13. A method for monitoring the location of a monitor target, the method comprising:
providing an articulating monitor device having at least a first piece connected to a second piece by a first movable connecting element, and a third piece connected to the second piece by a second movable connecting element; wherein a power source is incorporated into one of the first piece, the second piece or the third piece; and wherein location determination circuitry is incorporated into different one of the first piece, the second piece or the third piece; and
connecting a strap between the first piece and the second piece around the limb of the monitor target.

14. The method of claim 13, wherein transmission circuitry is incorporated into one of the first piece, the second piece or the third piece, and wherein the method further comprises:
transmitting location information from the articulating monitor device via the transmission circuitry to a central monitoring system.

15. The method of claim 13, wherein subject monitoring circuitry is incorporated into different one of the first piece, the second piece or the third piece.

16. The method of claim 15, wherein the subject monitoring circuitry includes one or more of the following: an alcohol sensor circuit, a heart rate sensor circuit, and an oxygen sensor circuit.

17. A multi-piece monitoring device, the monitoring device comprising:
a first piece having a first hinge element and a second hinge element integral to the second piece;
a second piece having a third hinge element integral to the second piece, wherein the first piece is connected to the second piece using the first hinge element and the third hinge element;
a third piece having a fourth hinge element integral to the third piece, wherein the third piece is connected to the first piece using the second hinge element and the fourth hinge element;
wherein a power source is incorporated into one of the first piece, the second piece or the third piece; and wherein location determination circuitry is incorporated into one of the first piece, the second piece or the third piece; and
a strap extending from the third piece and operable to connect to the second piece to secure the monitoring device around a limb of a monitor target.

18. The multi-piece monitoring device of claim 17, wherein the strap includes an electrical conductor operable to conduct an electrical signal between a first contact incorporated in the first piece and a second contact incorporated in the third piece.

19. The multi-piece monitoring device of claim 17, wherein a first inner surface of the first piece is curvilinear to conform to a curved shape of a limb, and wherein a second inner surface of the third piece is curvilinear to conform to the curved shape of the limb.

20. The multi-piece monitoring device of claim 17, wherein the power source includes both a removable battery incorporated in the first piece and a non-removable battery incorporated in at least one of the first piece, the second piece, or the third piece; and wherein the removable battery is detachable from the second piece and rechargeable.
